(19) United States
(12) Patent Application Publication
(10) Pub. No.: US 2014/0233749 A1
(43) Pub. Date: Aug. 21, 2014

(54) EARPHONE MICROPHONE

(71) Applicant: FUNAI ELECTRIC CO., LTD., Osaka (JP)

(72) Inventors: Noriyuki SHIMIZU, Osaka (JP); Fuminori TANAKA, Osaka (JP)

(73) Assignee: FUNAI ELECTRIC CO., LTD., Osaka (JP)

(21) Appl. No.: 14/175,003

(22) Filed: Feb. 7, 2014

(30) Foreign Application Priority Data
Feb. 20, 2013 (JP) 2013-030790
Jul. 23, 2013 (JP) 2013-153017

(51) Int. Cl. H04R 1/10

(52) U.S. Cl. CPC H04R 1/1083
USPC 381/71.6

(57) ABSTRACT

An earphone microphone includes a single speaker, a microphone having first and second sound input holes, and a main body casing in which an acoustic space is formed. The acoustic space includes a sound output path in which output sound propagates, a first sound input path communicating with outside, in which sound to be input to the first sound input hole propagates, and a second sound input path in which sound to be input to the second sound input hole propagates. The sound output path branches into one path communicating with outside of the main body casing and the other path communicating with the second sound input path. Input sound from a sound source outside the main body casing is input while input of output sound is suppressed by acoustic resistance of the acoustic space.

This application is based on Japanese Patent Application No. 2013-030790 filed on Feb. 20, 2013, and Japanese Patent Application No. 2013-153017 filed on Jul. 23, 2013, contents of which are hereby incorporated by reference.

### BACKGROUND OF THE INVENTION

1. Field of the Invention

The present invention relates to an earphone microphone, and particularly to an earphone microphone including a speaker and a microphone.

2. Description of Related Art

Conventionally, there is known an earphone microphone including a speaker and a microphone. Using the earphone microphone set in the ear, a user can hear sounds such as voice output from the speaker while transmitting sounds such as user's voice input to the microphone. Therefore, the earphone microphone is used for hands-free communication using a cellular phone or the like.

However, the sound output from the speaker to the user's external auditory meatus is echoed by the user's tympanum, the external auditory meatus, and the like to enter the earphone microphone as noise (echo component). Therefore, the microphone in the earphone microphone collects not only the user's voice but also the echo component of the sound output from the speaker. Consequently, there is a problem that the echo component is mixed as noise into the voice sound transmitted from the earphone microphone.

Therefore, there is known an earphone microphone having an echo cancel function as described in JP-A-2007-201887, for example. The earphone microphone described in JP-A-2007-201887 includes two speakers and a microphone. One of the speakers outputs sound such as speaking voice. The other speaker outputs sound for canceling the echo component of the sound output from the one of the speakers. The echo component of the sound output from the one of the speakers and the sound output from the other speaker are input to the microphone. Then, they are canceled by each other so that the echo component is suppressed.

However, the earphone microphone described in JP-A-2007-201887 includes a plurality of speakers in a main body casing. For this reason, a space for housing the speakers and their sound paths increases in the main body casing. Therefore, there is a problem that it is difficult to downsize the main body casing. In addition, there is another problem that it becomes relatively expensive because of manufacturing cost.

### SUMMARY OF THE INVENTION

The present invention is made in view of the above-mentioned situation, and it is an object thereof to provide an earphone microphone having an echo suppression function that is inexpensive and can be downsized.

In order to achieve the above-mentioned object, an earphone microphone according to a first aspect of the present invention includes a single speaker, a microphone, and a main body casing. The microphone has first and second sound input holes. An acoustic space is formed in the main body casing. The acoustic space includes a sound output path, a first sound input path, and a second sound input path. Sound output from the speaker propagates in the sound output path. The first sound input path communicates with outside of the main body casing, and sound to be input to the first sound input hole propagates in the path. Sound to be input to the second sound input hole propagates in the second sound input path. In addition, the sound output path branches to one path communicating with outside of the main body casing and the other path communicating with the second sound input path. Because of acoustic resistance of the acoustic space, input sound from a sound source outside the main body casing is input, while input of the output sound from the speaker is suppressed.

With this structure, the earphone microphone includes the single speaker. In addition, the sound output path branches into the one path communicating with outside of the main body casing and the other path communicating with the second sound input path. For this reason, the output sound from the speaker propagates to the first sound input hole via the one path and the first sound input path, and also propagates to the second sound input hole via the other path and the second sound input path. Further, because of the acoustic resistance of the acoustic space, the input sound from the outside sound source is collected, while input of the output sound from the speaker is suppressed. For this reason, the earphone microphone can realize the echo suppression function of the output sound from the speaker without using a plurality of speakers. Further, the earphone microphone can transmit input sound while suppressing noise due to the output sound from the speaker. Therefore, it is possible to provide an earphone microphone having the echo suppression function that is inexpensive and can be downsized.

Further features and advantages of the present invention will become apparent from the description of embodiments given below.

### BRIEF DESCRIPTION OF THE DRAWINGS

FIG. 1 is an outside perspective view of an earphone microphone.

FIG. 2 is a diagram illustrating the earphone microphone inserted into a user's external auditory meatus.

FIG. 3 is a cross-sectional view of a main body according to a first embodiment.

FIG. 4 is a front view of the main body viewed from the user's external auditory meatus in the first embodiment.

FIG. 5 is a side view of the main body.

FIG. 6A is a front view illustrating another example of forming second and third apertures in the first embodiment.

FIG. 6B is a front view illustrating still another example of forming the second and third apertures in the first embodiment.

FIG. 6C is a front view illustrating still another example of forming the second and third apertures in the first embodiment.

FIG. 7 is a conceptual structural diagram illustrating propagation paths of output sound from a speaker to be input to a microphone in the first embodiment.

FIG. 8 is a sound input block diagram of the output sound in the first embodiment.

FIG. 9 is a conceptual structural diagram illustrating propagation paths of input sound from an outside sound source to the microphone in the first embodiment.

FIG. 10 is a sound input block diagram of the input sound in the first embodiment.

FIG. 11 is a conceptual structural diagram of an earphone microphone according to a second embodiment.

FIG. 12 is a front view of a main body viewed from the user's external auditory meatus in the second embodiment.

FIG. 13A is a front view illustrating another example of forming second to fourth apertures in the second embodiment.

FIG. 13B is a front view illustrating still another example of forming the second to fourth apertures in the second embodiment.

FIG. 14 is a conceptual structural diagram illustrating propagation paths of output sound from a speaker to be input to a microphone in the second embodiment.

FIG. 15 is a sound input block diagram of the output sound in the second embodiment.

FIG. 16 is a conceptual structural diagram illustrating propagation paths of input sound from an outside sound source to the microphone in the second embodiment.

FIG. 17 is a sound input block diagram of the input sound in the second embodiment.

FIG. 18 is a cross-sectional view of a main body according to a third embodiment.

FIG. 19 is a graph illustrating an example of sensitivity characteristics of the microphone in case where the second sound input path has relatively large capacity in the third embodiment.

FIG. 20 is a graph illustrating an example of sensitivity characteristics of the microphone in case where the second sound input path has relatively small capacity in the third embodiment.

FIG. 21 is a graph illustrating an example of changing the center frequency with respect to capacity of the second sound input path.

FIG. 22 is a cross-sectional view of a main body in a modified example of the third embodiment.

### DETAILED DESCRIPTION OF THE PREFERRED EMBODIMENTS

Now, with reference to the drawings, embodiments of the present invention are described.

### First Embodiment

### (Structure of Earphone Microphone)

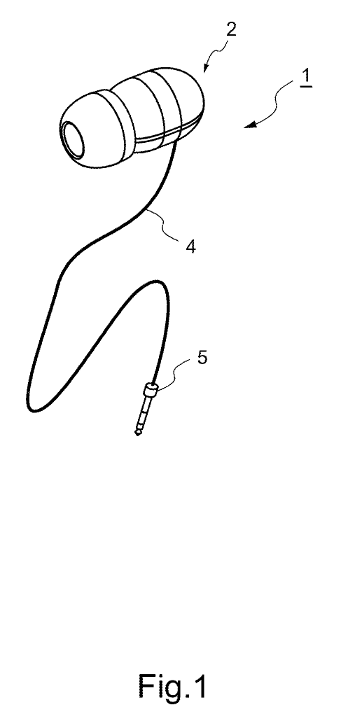

FIG. 1 is an outside perspective view of an earphone microphone. An earphone microphone 1 is a sound input and output device connected to electronic equipment (not shown) such as a cellular phone, for example. As illustrated in FIG. 1, the earphone microphone 1 includes a main body 2, a cable 4, and a connector 5.

The main body 2 is inserted into a user's ear, so as to output sound and to input sound from an outside sound source (for example, user's speaking voice). A specific structure of this main body 2 will be described later. The cable 4 is a signal line that is connected between the main body 2 and the connector 5 so as to transmit and receive signals via the connector 5 between the main body 2 and electronic equipment (not shown) connected to the earphone microphone 1. The connector 5 is an input and output terminal connected to an interface of the electronic equipment (not shown).

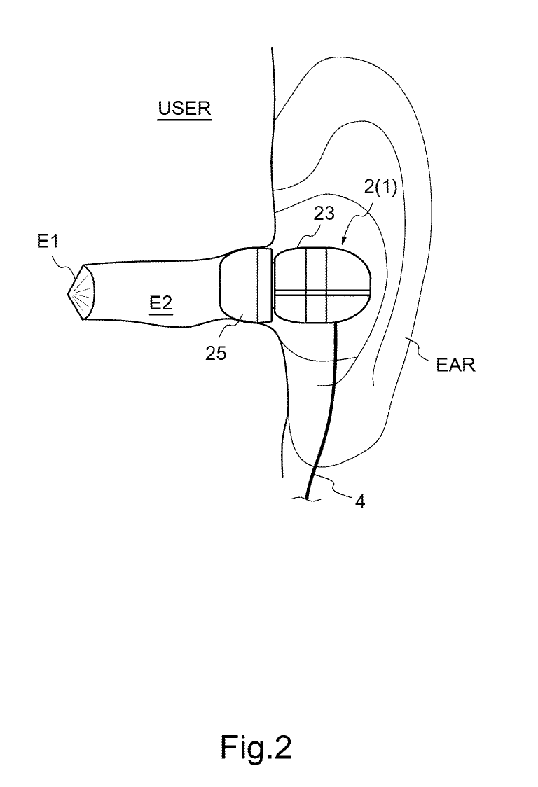

FIG. 2 is a diagram illustrating a state where the earphone microphone is inserted into a user's external auditory meatus. As illustrated in FIG. 2, the earphone microphone 1 is inserted in a user's ear EAR and outputs sound based on a sound signal output from the electronic equipment (not shown) to a user's tympanum E1. In addition, the voice generated by the user is not only output from the mouth, but also a part of the voice is transmitted through the skull or the face muscle and is output to an external auditory meatus E2 from the tympanum E1. The earphone microphone 1 inputs the sound such as user's speaking voice (namely input sound from the outside sound source) and further generates a sound signal based on the input sound so as to output the sound signal to the electronic equipment (not shown). Note that the electronic equipment connected to the earphone microphone 1 is not limited to a specific one.

Here, the output sound from the earphone microphone 1 to the user's external auditory meatus E2 is echoed by the user's tympanum E1, the inner wall of the external auditory meatus E2, and the like so as to enter the earphone microphone 1 as noise. In the following description, this noise is referred to as an echo component. The earphone microphone 1 has an echo suppression function for suppressing noise due to the echo component, as described later. For this reason, the earphone microphone 1 can input clear voice in which the noise (in particular, the echo component of the output sound) is suppressed.

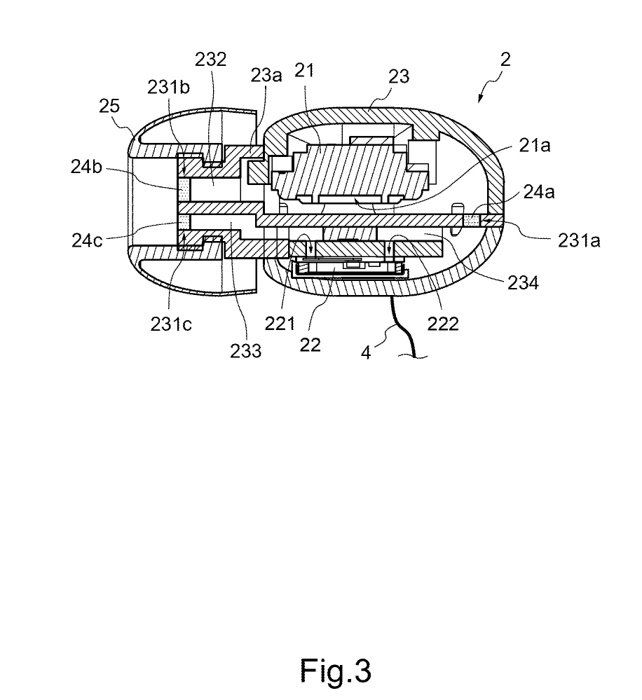

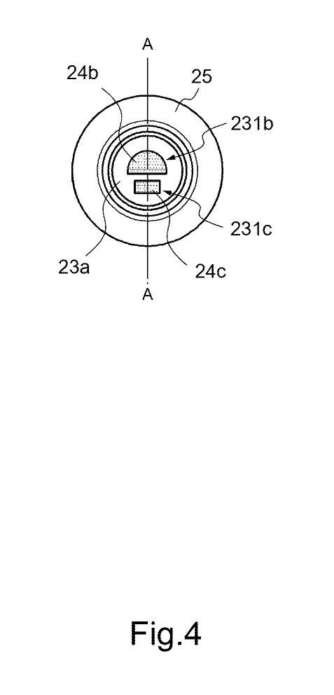

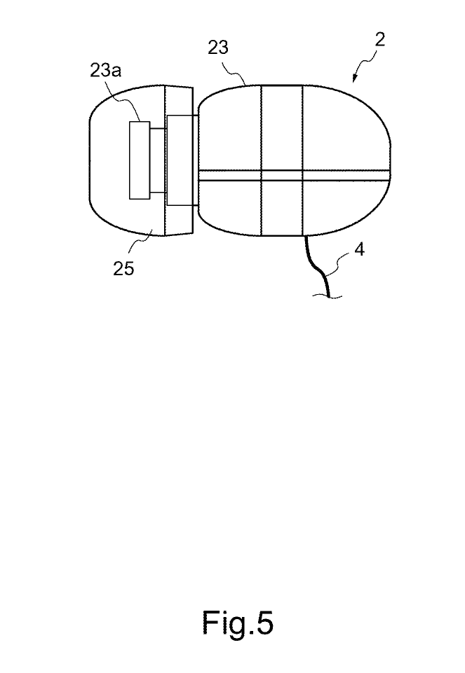

Next, a structure of the main body 2 is described in detail. FIG. 3 is a cross-sectional view of a main body in the first embodiment. In addition, FIG. 4 is a front view of the main body viewed from the user's external auditory meatus in the first embodiment. In addition, FIG. 5 is a side view of the main body. Note that FIG. 3 illustrates a cross-sectional structure of the main body 2 taken along a dashed dotted line A-A in FIG. 4.

As illustrated in FIG. 3, the main body 2 includes a speaker 21, a microphone 22, a main body casing 23, first to third acoustic resistors 24a to 24c, and an ear pad 25.

The speaker 21 is a voice output unit having a sound output hole 21a through which the output sound is output. The speaker 21 is electrically connected to the cable 4 so as to output the output sound based on a sound signal transmitted from the electronic equipment (not shown) via the cable 4 and the connector 5. Note that in FIG. 3, the sound output hole 21a of the speaker 21 faces a direction substantially perpendicular to the extending direction of a sound output path 232, but the direction of the speaker 21 is not limited to the direction exemplified in FIG. 3. The direction of the speaker 21 may be substantially parallel to the extending direction of the sound output path 232 described later, for example.

The microphone 22 is a differential microphone having first and second sound input holes 221 and 222 and is electrically connected to the cable 4. This microphone 22 is not limited to a specific one but may be an MEMS microphone or an ECM microphone. The microphone 22 generates a first sound signal on the basis of voice input to the first sound input hole 221 and generates a second sound signal on the basis of voice input to the second sound input hole 222. In addition, the microphone 22 generates a difference sound signal based on a difference between a sound pressure of the voice input to the first sound input hole 221 and a sound pressure of the voice input to the second sound input hole 222. The microphone 22 outputs these signals to the electronic equipment (not shown) via the cable 4 and the connector 5. Note that in FIG. 3, the first and second sound input holes 221 and 222 are arranged in a direction substantially parallel to the extending direction of the sound paths described later, but the arrangement direction of them is not limited to the one exemplified in FIG. 3.

In the main body casing 23, the single speaker 21 and the microphone 22 are mounted. In addition, as illustrated in FIGS. 3 to 5, an insertion part 23 a is formed in the main body casing 23. As illustrated in FIG. 4, second and third apertures 231b and 231c for inputting and outputting voice to the earphone microphone 1 are formed in the insertion part 23a on a surface opposed to the user's tympanum E1 when the main body 2 is set to the user's ear EAR as illustrated in FIG. 2.

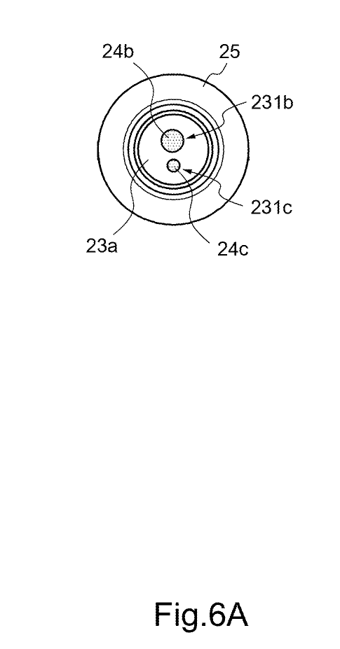

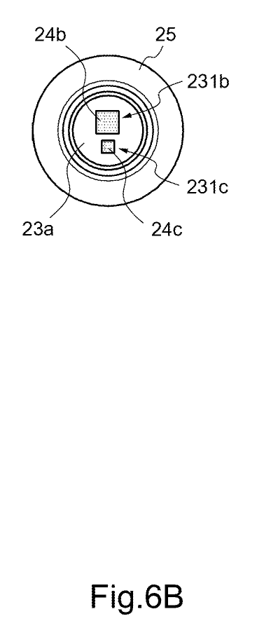

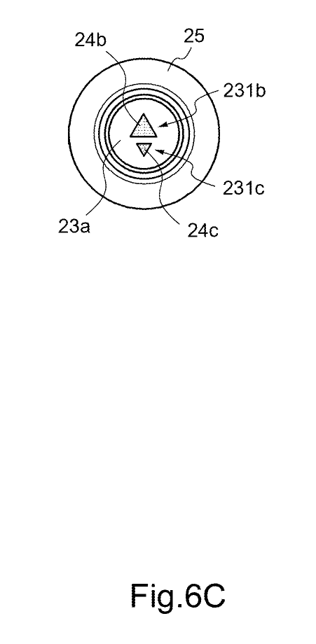

Note that shapes of the second and third apertures 231b and 231c formed in the insertion part 23a are not limited particularly. FIGS. 6A to 6C are front views illustrating other examples of forming the second and third apertures in the first embodiment. The shapes of the second and third apertures 231b and 231c may be a circular shape (FIG. 6A) or a polygonal shape such as a square (FIG. 6B) or a triangle (FIG. 6C), for example. In addition, shapes as well as sizes of the second and third apertures 231b and 231c may be substantially the same or may be different.

In addition, as illustrated in FIG. 3, an acoustic space including the sound output path 232, a first sound input path 233, and a second sound input path 234 is formed in the main body casing 23. Note that sounds propagating in the sound paths 232 to 234 are attenuated by acoustic resistances r1 to r3. The acoustic resistances r1 to r3 indicate attenuation ratios of sound pressures of the sounds propagating in the sound paths 232 to 234. The acoustic resistances r1 to r3 have values corresponding to internal shapes and sizes, and materials of inner walls of the sound paths.

The sound output path 232 is a sound path in which output sound from the speaker 21 propagates. In this sound output path 232, the speaker 21 is disposed, and a first aperture 231a is formed so as to communicate with the second sound input path 234. For this reason, the sound output path 232 from the speaker 21 branches into one path communicating with outside of the main body casing 23 and the other path communicating with the second sound input path 234 via the first aperture 231a. The one path communicates with the second aperture 231b so as to permit the output sound from the sound output hole 21a of the speaker 21 to be output to the outside of the main body casing 23 via the second aperture 231b. The other path permits the output sound to propagate to the second sound input path 234 via the first aperture 231a. Note that a branch sound path for communicating the sound output path 232 with the second sound input path 234 may be formed instead of the first aperture 231a illustrated in FIG. 3 between the sound output path 232 and the second sound input path 234.

The first sound input path 233 is a sound path in which sound input to the first sound input hole 221 propagates and communicates with the third aperture 231c. An echo component of output sound from the speaker 21 and input sound from the outside sound source (for example, user's speaking voice propagating via the tympanum E1 and the external auditory meatus E2) propagates from the outside of the main body casing 23 to the first sound input path 233 via the third aperture 231c. The first sound input path 233 conducts the sounds to the first sound input hole 221.

In addition, the second sound input path 234 is a sound path in which sound input to the second sound input hole 222 propagates. Sounds such as the echo component of output sound from the speaker 21 and the input sound from the outside sound source propagate from outside of the main body casing 23 to the second sound input path 234 via the second aperture 231b, the sound output path 232, and the first aperture 231a. Further, the output sound from the speaker 21 propagates directly to the second sound input path 234 via the sound output path 232 and the first aperture 231a. The second sound input path 234 conducts these sounds to the second sound input hole 222.

The first to third acoustic resistors 24a to 24c are members functioning as acoustic resistances for attenuating sound pressure of sound passing through them. The acoustic resistance of the first acoustic resistor 24a is denoted by R1. The acoustic resistance of the second acoustic resistor 24b is denoted by R2. The acoustic resistance of the third acoustic resistor 24c is denoted by R3. The acoustic resistances R1 to R3 indicate attenuation ratios of sound pressures of the sounds that are attenuated after passing through the acoustic resistors 24a to 24c, and are set to values larger than zero and smaller than one in accordance with specification of the earphone microphone 1 (0<R1, R2, and R3<1). For this reason, when the sound wave having a sound pressure P passes through the first acoustic resistor 24a, for example, the sound pressure after the passing through becomes P*(1-R1). The same is true for other acoustic resistors 24b and 24c.

As illustrated in FIG. 3, the first to third acoustic resistors 24a to 24c are disposed in the individual sound paths included in the acoustic space in the main body casing 23. The first to third acoustic resistors 24a to 24c may be made of mesh, felt, or a film in which a plurality of holes are formed, for example. In addition, the material of the first to third acoustic resistors 24a to 24c is not limited to a specific one, but may be a resin material such as nylon or polyimide. In addition, the first to third acoustic resistors 24a to 24c may be the same member or may be different members.

Note that in FIG. 3, the first to third acoustic resistors 24a to 24c are disposed in the sound paths 232 to 234 (or the apertures 231a to 231c), respectively, but the application range of the present invention is not limited to the structure of FIG. 3. The first to third acoustic resistors 24a to 24c may be disposed in at least one of the sound paths 232 to 234. In addition, the first to third acoustic resistors 24a to 24c may be glued to the apertures 231a to 231c or may be disposed at predetermined positions in the sound paths 232 to 234.

The ear pad 25 is made of a resin material, for example, and is configured to cover the insertion part 23a. When the main body 2 is set to the user's ear EAR (see FIG. 2), the ear pad 25 is inserted together with the insertion part 23a into the user's external auditory meatus E2. In this case, the ear pad 25 seals a space between the insertion part 23a and the user's external auditory meatus E2 without a substantial gap. For this reason, external sound entering through the space between the insertion part 23a and the external auditory meatus E2 can be substantially blocked.

### (Echo Suppression Function of Earphone Microphone)

Next, the echo suppression function of the earphone microphone 1 according to the first embodiment is described in a case where the output sound from the speaker 21 is input to the microphone 22, and in a case where the input sound from the outside sound source (such as user's speaking voice) is input to the microphone 22.

((In Case where Output Sound from Speaker is Input to Microphone))

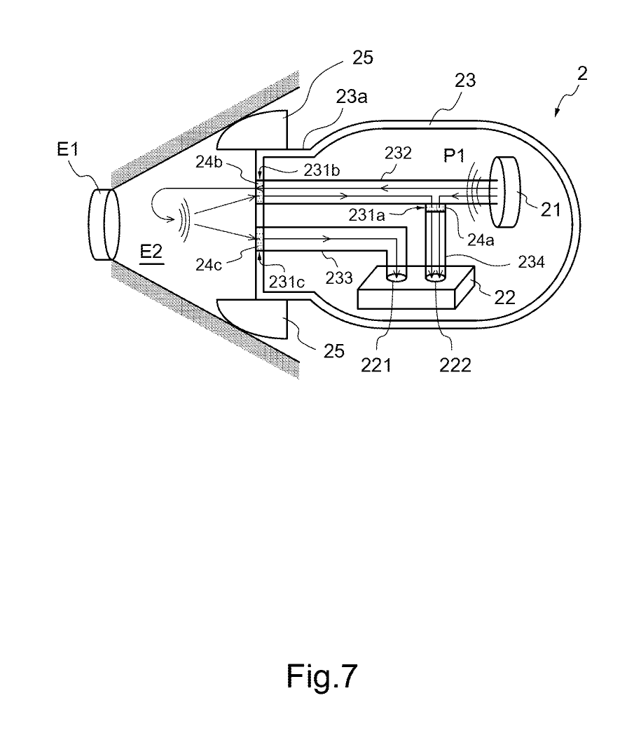

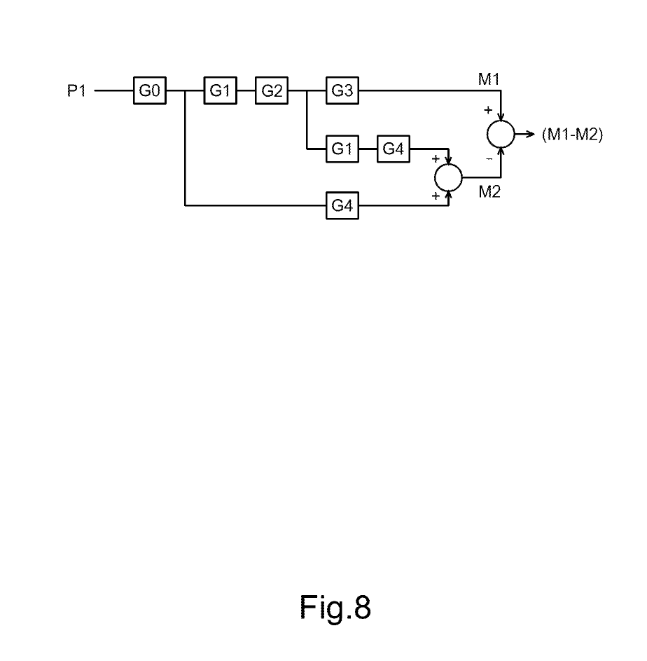

First, the case where the output sound from the speaker 21 is input to the microphone 22 is described. FIG. 7 is a conceptual structural diagram illustrating a propagation path of the output sound from the speaker to be input to the microphone in the first embodiment. In addition, FIG. 8 is a sound input block diagram of the output sound in the first embodiment. Note that in FIG. 7, the sound output direction of the speaker 21 is substantially parallel to the sound output path 232 for convenience sake. In addition, in FIG. 8, when the earphone microphone 1 is inserted in the user's external auditory meatus E2 as illustrated in FIG. 2, acoustic resistances for attenuating the sound are denoted by sound transmission ratios G0 to G4, respectively. The sound transmission ratios G0 to G4 indicate variation ratios of the sound pressure of the sound before and after passing through the sound paths 232 to 234, the external auditory meatus E2, and the first to third acoustic resistors 24a to 24c.

Acoustic resistance indicated by the sound transmission ratio G0 contains a part of acoustic resistance r1 of the sound output path 232 and the like. Note that the part of acoustic resistance r1 means acoustic resistance that attenuates the sound propagating in a section from the speaker 21 (sound output hole 21a) to the first aperture 231a along the sound output path 232.

In addition, acoustic resistance indicated by the sound transmission ratio G1 contains the remaining part of the acoustic resistance r1 of the sound output path 232, the acoustic resistance R2 of the second acoustic resistor 24b disposed in the second aperture 231b, and the like. Note that the remaining part of the acoustic resistance r1 means acoustic resistance that attenuates the sound propagating in a section from the first apertures 231a to the second aperture 231b along the sound output path 232.

In addition, acoustic resistance indicated by the sound transmission ratio G2 contains acoustic resistance r2 in the external auditory meatus E2 due to shapes, sizes, materials, and the like of the tympanum E1 and the external auditory meatus E2, and the like.

In addition, acoustic resistance indicated by the sound transmission ratio G3 contains the acoustic resistance R3 of the third acoustic resistor 24c disposed in the third aperture 231c, the acoustic resistance r3 of the first sound input path 233, and the like.

In addition, acoustic resistance indicated by the sound transmission ratio G4 contains the acoustic resistance R1 of the first acoustic resistor 24a disposed in the first aperture 231a, acoustic resistance r4 of the second sound input path 234, and the like.

The sound transmission ratios G0 to G4 have values larger than zero and smaller than one in accordance with specification of the earphone microphone 1 (0<G0 to G4<1). For this reason, when the sound wave having the sound pressure P is attenuated by the acoustic resistance of the sound transmission ratio G1, for example, the sound pressure thereof becomes P*G1. The same is true for other acoustic resistances of the sound transmission ratios G0 and G2 to G4. Note that in this embodiment, the sound transmission ratio G0 can be regarded as substantially one because the acoustic resistance r1 is sufficiently small.

As illustrated in FIG. 7, the output sound having the sound pressure P1 output from the speaker 21 propagates from the speaker 21 to the sound output path 232 and the second acoustic resistor 24b and is output to the external auditory meatus E2. Therefore, the sound pressure of the output sound becomes P1*G0*G1 as illustrated in FIG. 8.

Further, the output sound output to the external auditory meatus E2 is echoed by the user's tympanum E1, the inner wall of the external auditory meatus E2, and the like. Therefore, the sound pressure of the echoed output sound (namely echo component) becomes (P1*G0*G1)*G2 as illustrated in FIG. 8. This echo component propagates to the first sound input path 233 and the sound output path 232.

The echo component propagating to the first sound input path 233 passes through the third aperture 231c and the first sound input path 233 so as to enter the first sound input hole 221. Therefore, first sound pressure M1 of the echo component entering the first sound input hole 221 is expressed by the following expression 1 as illustrated in FIG. 8.

M1=P1*G0*G1*G2*G3 (expression 1)

On the other hand, the echo component propagating to the sound output path 232 passes through the second aperture 231b, the sound output path 232, the first aperture 231a, and the second sound input path 234 so as to enter the second sound input hole 222. Therefore, sound pressure of the echo component entering the second sound input hole 222 becomes {(P1*G0*G1)*G2}*G1*G4 as illustrated in FIG. 8.

In addition, the output sound from the speaker 21 is directly input to the second sound input hole 222 from the sound output hole 21a of the speaker 21 via a part of the sound output path 232, the first aperture 231a, and the second sound input path 234. In this case, sound pressure of the output sound to be input to the second sound input hole 222 becomes P1*G0*G4 as illustrated in FIG. 8.

For this reason, second sound pressure M2 of the sound input to the second sound input hole 222 (namely the echo component and the output sound) is expressed by the following expression 2.

M2=P1*G0*(G1*G1*G2*G4+G4) (expression 2)

Here, a difference |M1−M2| between the first sound pressure M1 at the first sound input hole 221 and the second sound pressure M2 at the second sound input hole 222 becomes as expressed by the following expression 3. By decreasing the value of this expression 3, the echo component of the output sound from the speaker 21 to be input to the microphone 22 can be suppressed.

|M1−M2|=P1*G0*G1*G2*G3−P1*G0*(G1*G1*G2*G4+G4) (expression 3)

The difference |M1−M2| between the first and second sound pressures M1 and M2 is preferably close to zero, and more preferably smaller than (0.1*P1), for example.

Further, if the first sound pressure M1 at the first sound input hole 221 and the second sound pressure M2 at the second sound input hole 222 are substantially equal to each other (M1≈M2), the microphone 22 generates a difference signal based on the first and second sound signals, and hence the echo component of the output sound from the speaker 21 can be substantially canceled. Thus, if (M1−M2)≈0 holds, the following expression 4 is derived.

G3≈G1*G4+G4/(G1*G2) (expression 4)

In other words, if the sound transmission ratios G0 to G4 satisfy the expression 4, the echo component of the output sound from the speaker 21 can be substantially eliminated. For instance, when the sound transmission ratio G2 in the external auditory meatus E2 is 0.5, sound transmission ratios of the sound paths are set as G0≈1, G1=0.5, G3=0.9, and G4=0.2. In this way, the first and second sound pressures M1 and M2 are equal to each other (both are 0.225*P1). Therefore, the earphone microphone 1 can eliminate the echo component of the output sound from the speaker 21. Note that these set values are an example, and the application range of the present invention is not limited to this example.

((Case where Input Sound from Outside Sound Source is Input to Microphone))

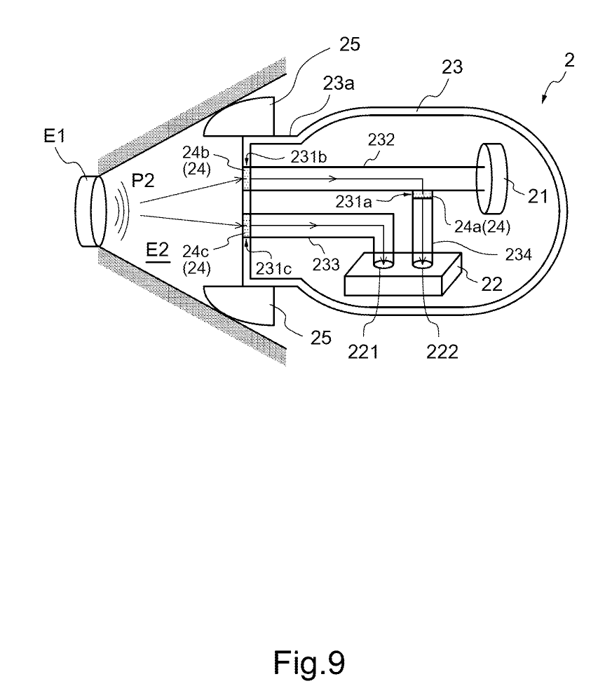

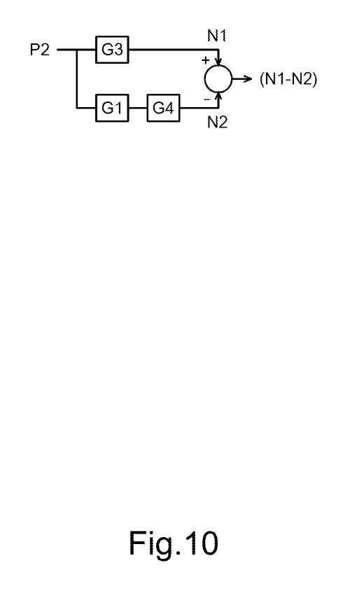

Next, the case where the input sound from the outside sound source (such as user's speaking voice) is input to the microphone 22 is described. FIG. 9 is a conceptual structural diagram illustrating a propagation path of the input sound from the outside sound source to the microphone in the first embodiment. In addition, FIG. 10 is a sound input block diagram of the input sound in the first embodiment. Note that in FIG. 9, the sound output direction of the speaker 21 is substantially parallel to the sound output path 232 for convenience sake.

As illustrated in FIG. 9, when the earphone microphone 1 is inserted in the user's external auditory meatus E2 as illustrated in FIG. 2, the input sound having sound pressure P2 propagates from the tympanum E1 and the external auditory meatus E2 to the first sound input path 233 and the sound output path 232. The input sound propagating in the first sound input path 233 passes through the third aperture 231c and the first sound input path 233 so as to enter the first sound input hole 221. Therefore, as illustrated in FIG. 10, third sound pressure N1 of the input sound input to the first sound input hole 221 is expressed by the following expression 5.

N1=P2*G3 (expression 5)

On the other hand, the input sound propagating in the sound output path 232 passes through the second aperture 231b, a part of the sound output path 232, the first aperture 231a, and the second sound input path 234 so as to enter the second sound input hole 222. Therefore, as illustrated in FIG. 10, fourth sound pressure N2 of the input sound input to the second sound input hole 222 is expressed by the following expression 6.

N2=P2*G1*G4 (expression 6)

Here, if one of the third sound pressure N1 at the first sound input hole 221 and the fourth sound pressure N2 at the second sound input hole 222 is larger than the other, the input sounds are not canceled, and hence a difference sound signal corresponding to a difference |N1−N2| between the sound pressures is generated. Therefore, the following expressions 7 and 8 are derived.

|N1−N2|=P2(G3−G1*G4)|>0 (expression 7)

|G3−(G1*G4)|22 0 (expression 8)

In other words, if the sound transmission ratios G0 to G4 are set so as to satisfy the expression 7 (expression 8), the input sound from the outside sound source is not canceled by the echo suppression function, and the difference sound signal having the sound pressure level corresponding to the difference |N1−N2| between the third and fourth sound pressures N1 and N2 is generated. Therefore, the earphone microphone 1 can transmit the input sound from the outside sound source (such as user's speaking voice) to the electronic equipment without mixing the echo component of the output sound from the speaker 21 as noise.

For instance, if the sound transmission ratios of the acoustic resistances of the sound paths are set as G1=0.5, G3=0.9, and G4=0.2, the third sound pressure becomes N1=(0.9*P2), and the fourth sound pressure becomes N2=(0.1*P2). Therefore, the earphone microphone 1 can transmit the input sound having a level corresponding to the difference |0.8*P2| between them to the electronic equipment. Note that these set values are merely an example, and the application range of the present invention is not limited to this example. The difference |N1−N2| between the third and fourth sound pressures N1 and N2 is preferably larger and more preferably is (0.7*P2) or larger, for example.

In addition, the level of the sound transmitted by the earphone microphone 1 becomes higher in the condition where the difference |N1−N2| between the third and fourth sound pressures N1 and N2 becomes largest. Therefore, the sound transmission ratios G0 to G4 are preferably set to the condition where |G3−(G1*G4)| becomes largest (namely, the value of the expression 7 or 8 becomes largest). In this way, the sound pressure level of the input sound in which noise due to the echo component of the output sound from the speaker 21 is suppressed can be maximized Therefore, the input sound from the outside sound source to the earphone microphone 1 can be transmitted with the highest sound pressure level.

### ((Suppression of Echo Component))

In reality, the microphone 22 simultaneously inputs the output sound from the speaker 21 and the input sound from the outside sound source (such as user's speaking voice). For this reason, the sound transmission ratios G0 to G4 are set so that the value of the expression 3 becomes smaller in the condition where the expression 8 is satisfied. In this way, the echo suppression function can be realized in the earphone microphone 1, and it is possible to transmit to the electronic equipment (not shown) the input sound in which the echo component of the output sound from the speaker 21 is suppressed by the echo suppression function.

In addition, the sound transmission ratios G0 to G4 are preferably set so as to satisfy the expression 4 and the expression 8. In this way, the echo suppression function of the earphone microphone 1 can be used to the full so as to transmit to the electronic equipment (not shown) the input sound from which the echo component of the output sound from the speaker 21 is substantially removed.

Note that as described above, in the condition where the value of the expression 7 or the expression 8 is small, the sounds input to the first and second sound input holes 221 and 222 can be easily canceled. Therefore, the sound transmission ratios G0 to G4 are preferably set to the condition where the value of the expression 8 becomes largest in the condition where the expression 4 is satisfied. In this way, the earphone microphone 1 can transmit to the electronic equipment (not shown) the input sound from which the echo component of the output sound from the speaker 21 is substantially removed.

The first embodiment is described above. According to the first embodiment, the earphone microphone 1 includes the single speaker 21, the microphone 22, and the main body casing 23. The microphone 22 includes the first and second sound input holes 221 and 222. The acoustic space is formed in the main body casing 23. The acoustic space includes the sound output path 232, the first sound input path 233, and the second sound input path 234. The output sound from the speaker 21 propagates in the sound output path 232. The first sound input path 233 communicates with the outside of the main body casing 23, and the sound input through the first sound input hole 221 propagates in the first sound input path 233. The sound input through the second sound input hole 222 propagates in the second sound input path 234. The sound output path 232 branches into the one path communicating with the outside of the main body casing 23 and the other path communicating with the second sound input path 234. With the acoustic resistances (indicated by the sound transmission ratios G0 to G4) of the acoustic space, the input sound from the sound source outside the main body casing 23 (such as user's speaking voice output via the user's tympanum E1 and external auditory meatus E2, for example) is input while input of the output sound from the speaker 21 is suppressed.

With this structure, the earphone microphone 1 includes the single speaker 21. In addition, the sound output path 232 branches into the one path communicating with the outside of the main body casing 23 and the other path communicating with the second sound input path 234. For this reason, the output sound from the speaker 21 propagates to the first sound input hole 221 via the one path and the first sound input path 233, and propagates to the second sound input hole 222 via the other path and the second sound input path 234. Further, with the acoustic resistances of the acoustic space (indicated by the sound transmission ratios G0 to G4), the input sound from the outside sound source (such as user's speaking voice) is input, while input of the output sound from the speaker 21 is suppressed. For this reason, the earphone microphone 1 can realize the echo suppression function of the output sound from the speaker 21 without using a plurality of speakers. Further, the earphone microphone 1 can transmit the input sound while suppressing noise due to the output sound from the speaker 21. Therefore, it is possible to provide the earphone microphone 1 having the echo suppression function, which is inexpensive and can be downsized.

In addition, in this embodiment, with the acoustic resistances of the acoustic space (indicated by the sound transmission ratios G0 to G4), it is desired that the first sound pressure M1 of the output sound from the speaker 21 to be input to the first sound input hole 221 is substantially equal to the second sound pressure M2 of the output sound to be input to the second sound input hole 222. Further, it is desired that one of the third sound pressure N1 of the input sound from the outside sound source (such as user's speaking voice) to be input to the first sound input hole 221 and the fourth sound pressure N2 of the input sound to be input to the second sound input hole 222 is larger than the other.

In this way, using the acoustic resistances of the acoustic space, the first and second sound pressures M1 and M2 of the input sounds input to the first and second sound input holes 221 and 222 are set to be substantially equal to each other, so that the output sounds from the speaker 21 input to the first and second sound input holes 221 and 222 can be canceled by each other. Further, one of the third and fourth sound pressures N1 and N2 of the input sounds from the outside sound source (such as user's speaking voice) to be input to the first and second sound input holes 221 and 222 is set to be larger than the other, and hence the input sounds are not canceled by the echo suppression function. Thus, the input sound having the sound pressure corresponding to the difference |N1−N2| between the third and fourth sound pressures N1 and N2 can be transmitted.

In addition, in this embodiment, the acoustic resistors 24a to 24c are disposed respectively to the sound paths 232 to 234 included in the acoustic space.

In this way, without restricted by shapes and sizes of the sound paths 232 to 234, the acoustic resistances (indicated by the sound transmission ratios G1 to G4) of the sound paths in which the acoustic resistors 24a to 24c are disposed can be set. Therefore, flexibility in designing the earphone microphone 1 can be enhanced, and hence the echo suppression function can be realized more easily.

In addition, in this embodiment, as to the acoustic resistances R1 to R3 of the acoustic resistors 24a to 24c, it is desired that the first sound pressure M1 of the output sound input to the first sound input hole 221 is substantially equal to the second sound pressure M2 of the output sound input to the second sound input hole 222. Further, it is desired that the difference |N1−N2| between the third sound pressure N1 of the input sound input to the first sound input hole 221 and the fourth sound pressure N2 of the input sound input to the second sound input hole 222 becomes largest.

In this way, by setting the acoustic resistances R1 to R3 of the acoustic resistors 24a to 24c, the first and second sound pressures M1 and M2 of the output sound become substantially equal to each other, and the difference |N1−N2| between the third and fourth sound pressures N1 and N2 of the input sounds becomes largest. This is because that the acoustic resistances r1 to r3 of the sound paths 232 to 234 are sufficiently smaller than the acoustic resistances R1 to R3 of the acoustic resistors 24a to 24c. Therefore, by setting the acoustic resistances R1 to R3 of the acoustic resistors 24a to 24c, the acoustic resistances (indicated by the sound transmission ratios G0 to G4) of the acoustic space can be adjusted. Therefore, the input sound from which noise due to the output sound from the speaker 21 is substantially removed can be transmitted with the highest sound pressure level.

### Second Embodiment

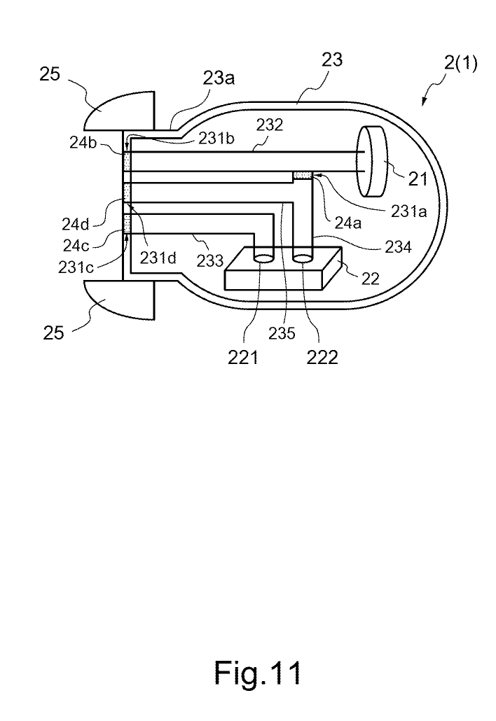

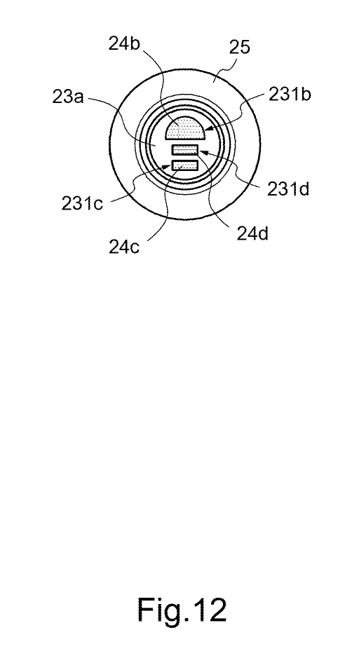

Next, the earphone microphone 1 of a second embodiment is described. FIG. 11 is a conceptual structural diagram of the earphone microphone according to the second embodiment. In addition, FIG. 12 is a front view of the main body viewed from the user's external auditory meatus in the second embodiment.

As illustrated in FIGS. 11 and 12, in the second embodiment, a fourth aperture 231d is further formed on the surface of the insertion part 23a on which the second and third apertures 231b and 231c are formed. A fourth acoustic resistor 24d is disposed in this fourth aperture 231d. In addition, the acoustic space inside the main body casing 23 further include a third sound input path 235 communicating with the second sound input path 234 from the outside of the main body casing 23 via the fourth aperture 231d. Other than that is the same as the first embodiment. In the following description, the same structure as in the first embodiment is denoted by the same numeral, and description thereof is omitted.

### (Structure of Earphone Microphone)

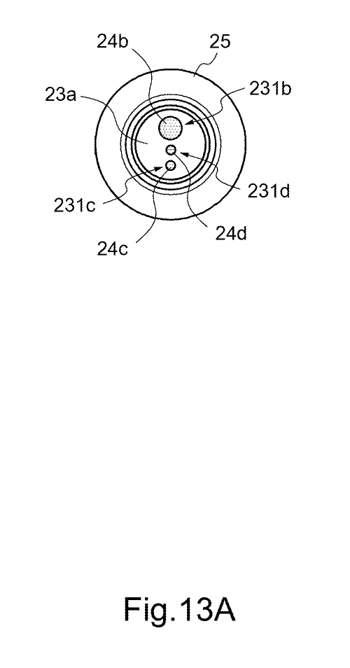

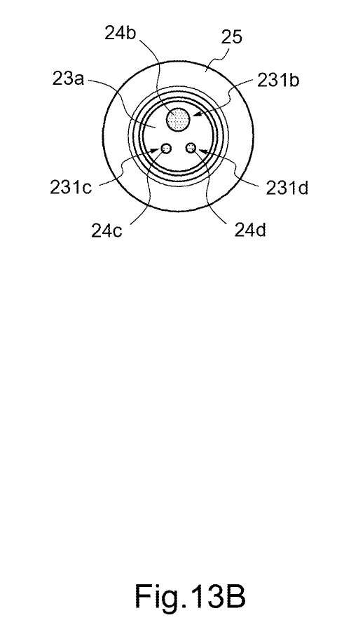

In the second embodiment, as illustrated in FIGS. 11 and 12, the insertion part 23a has three apertures (second to fourth apertures 231b, 231c, and 231d), which are formed on the surface opposed to the user's tympanum E1 when the main body 2 is set to the user's ear EAR. Note that shapes of the apertures 231b, 231c, and 231d formed in the insertion part 23a are not limited to specific shapes. FIGS. 13A and 13B are front views illustrating other examples of forming the second to fourth apertures in the second embodiment. For instance, the shapes of the second to fourth apertures 231b, 231c, and 231d may be a circular shape as illustrated in FIG. 13A or may be a polygonal shape such as a rectangle or a triangle. In addition, the shapes as well as the sizes of the second to fourth apertures 231b, 231c, and 231d may be substantially the same or may be different from each other. In addition, the second to fourth apertures 231b, 231c, and 231d may be aligned in a predetermined direction as illustrated in FIGS. 12 and 13A, or the centers of the apertures 231b, 231c, and 231d may be arranged at apexes of an imaginary triangle as illustrated in FIG. 13B.

In addition, the fourth acoustic resistor 24d having an acoustic resistance R4 is disposed in the fourth aperture 231d. This acoustic resistance R4 indicates a variation ratio of the sound pressure of the sound that is attenuated after passing through the fourth acoustic resistor 24d and is set to a value larger than zero and smaller than one (0<R4<1) in accordance with specification of the earphone microphone 1.

### (Echo Suppression Function of Earphone Microphone)

Next, the echo suppression function of the earphone microphone 1 according to the second embodiment is described in a case where the output sound from the speaker 21 is input to the microphone 22, and in a case where the input sound from the outside sound source (such as user's speaking voice) is input to the microphone 22.

((In Case where Output Sound from Speaker is Input to Microphone))

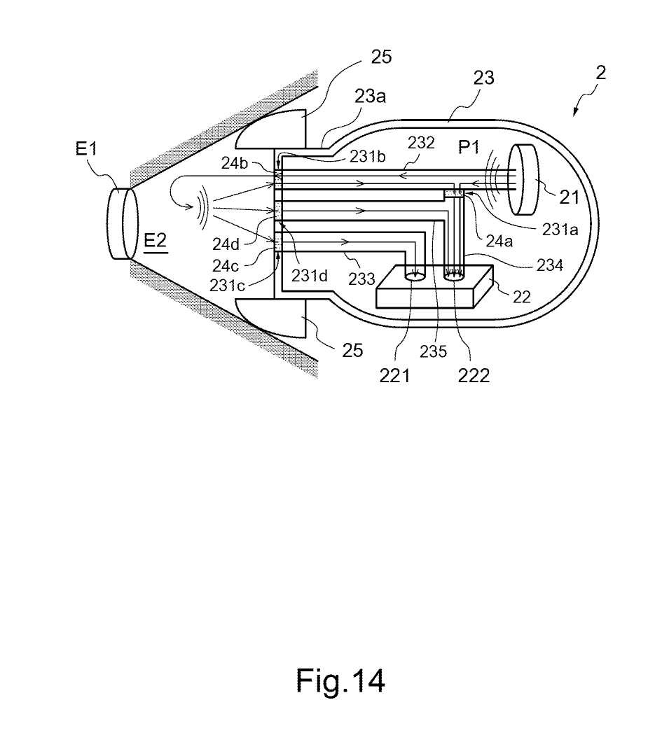

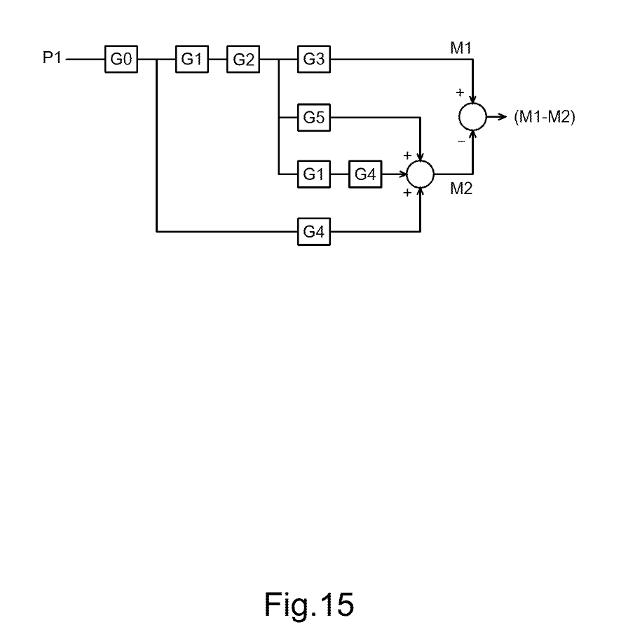

First, the case where the output sound from the speaker 21 is input to the microphone 22 is described. FIG. 14 is a conceptual structural diagram illustrating a propagation path of the output sound from the speaker to be input to the microphone in the second embodiment. In addition, FIG. 15 is a sound input block diagram of the output sound in the second embodiment. Note that in FIG. 14, the sound output direction of the speaker 21 is substantially parallel to the sound output path 232 for convenience sake. In addition, in FIG. 15, when the earphone microphone 1 is inserted in the user's external auditory meatus E2 as illustrated in FIG. 2, acoustic resistances for attenuating the sound are denoted by sound transmission ratios G0 to G5, respectively. The sound transmission ratios G0 to G5 indicate variation ratios of the sound pressure of the sound before and after passing through the sound paths 232 to 235, the external auditory meatus E2, and the first to fourth acoustic resistors 24a to 24d.

Note that the acoustic resistance indicated by the sound transmission ratio G5 includes the acoustic resistance R4 of the fourth acoustic resistor 24d disposed in the fourth aperture 231d, acoustic resistance r5 of the third sound input path 235, the acoustic resistance r4 of the second sound input path 234, and the like. This sound transmission ratio G5 has a value larger than zero and smaller than one (0<G5<1) in accordance with specification of the earphone microphone 1.

As illustrated in FIG. 14, the output sound having the sound pressure P1 output from the speaker 21 passes through the sound output path 232 and the second acoustic resistor 24b so as to be output from the speaker 21 to the external auditory meatus E2. Therefore, the sound pressure of the output sound becomes P1*G0*G1 as illustrated in FIG. 15.

Further, the output sound output to the external auditory meatus E2 is echoed by the user's tympanum E1, the inner wall of the external auditory meatus E2, and the like. Therefore, the sound pressure of the echoed output sound (namely echo component) becomes (P1*G0*G1)*G2 as illustrated in FIG. 15. This echo component propagates in the first sound input path 233, the third sound input path 235, and the sound output path 232.

The echo component propagating in the first sound input path 233 is input to the first sound input hole 221 via the third aperture 231c and the first sound input path 233. Therefore, as illustrated in FIG. 15, the first sound pressure M1 of the echo component input to the first sound input hole 221 is expressed by the following expression 9.

M1=P1*G0*G1*G2*G3 (expression 9)

In addition, the echo component propagating in the third sound input path 235 passes through the fourth aperture 231d, the third sound input path 235, and the second sound input path 234 so as to enter the second sound input hole 222. Therefore, the sound pressure of the echo component input to the second sound input hole 222 after propagating in the third sound input path 235 becomes {(P1*G0*G1)*G2}*G5 as illustrated in FIG. 15.

In addition, the echo component propagating in the sound output path 232 passes through the second aperture 231b, the sound output path 232, the first aperture 231a, and the second sound input path 234 so as to enter the second sound input hole 222. Therefore, the sound pressure of the echo component input to the second sound input hole 222 after propagating in the sound output path 232 becomes {(P1*G0*G1)*G2}*G1*G4 as illustrated in FIG. 15.

In addition, the output sound from the speaker 21 is directly input from the sound output hole 21a of the speaker 21 to the second sound input hole 222 via a part of the sound output path 232, the first aperture 231a, and the second sound input path 234. In this case, the sound pressure of the output sound input to the second sound input hole 222 becomes P1*G0*G4 as illustrated in FIG. 15.

For this reason, the second sound pressure M2 of the sound input to the second sound input hole 222 (namely the echo component and the output sound) is expressed by the following expression 10.

M2=P1*G0{G1*G2*(G5+G1*G4)+G4} (expression 10)

Here, the difference |M1−M2| between the first sound pressure M1 at the first sound input hole 221 and the second sound pressure M2 at the second sound input hole 222 is expressed by the following expression 11. By reducing the value of the expression 11, it is possible to suppress the echo component of the output sound from the speaker 21 to the microphone 22.

|M1−M2|=P1*G0*G1x*G2*G3−P1*G0{G1*G2*(G5+G1*G4)+G4} (expression 11)

The difference |M1−M2| between the first and second sound pressures M1 and M2 is preferably close to zero, and is more preferably (0.1*P1) or smaller, for example.

Further, when the first sound pressure M1 at the first sound input hole 221 and the second sound pressure M2 at the second sound input hole 222 are substantially equal to each other (M1 M2), the microphone 22 generates the difference signal based on the first and second sound signals so that the echo component of the output sound from the speaker 21 can be substantially canceled. Therefore, when (M1−M2)≈0 holds, the following expression 12 is derived.

G3≈G5+G1*G4+G4/(G1*G2) (expression 12)

In other words, when the sound transmission ratios G0 to G5 satisfy the expression 12, the echo component of the output sound from the speaker 21 can be substantially canceled. For instance, when the sound transmission ratio G2 in the external auditory meatus E2 is 0.5, the sound transmission ratios of the sound paths are set as G0≈1, G1=0.70, G3=0.94, G4=0.25, and G5=0.05. Then, the first and the second sound pressures M1 and M2 are both approximately (0.33*P1) and are substantially equal to each other. Therefore, the earphone microphone 1 can cancel the echo component of the output sound from the speaker 21. Note that these set values are an example, and the application range of the present invention is not limited to this example.

((In Case where Input Sound from Outside Sound Source is Input to Microphone))

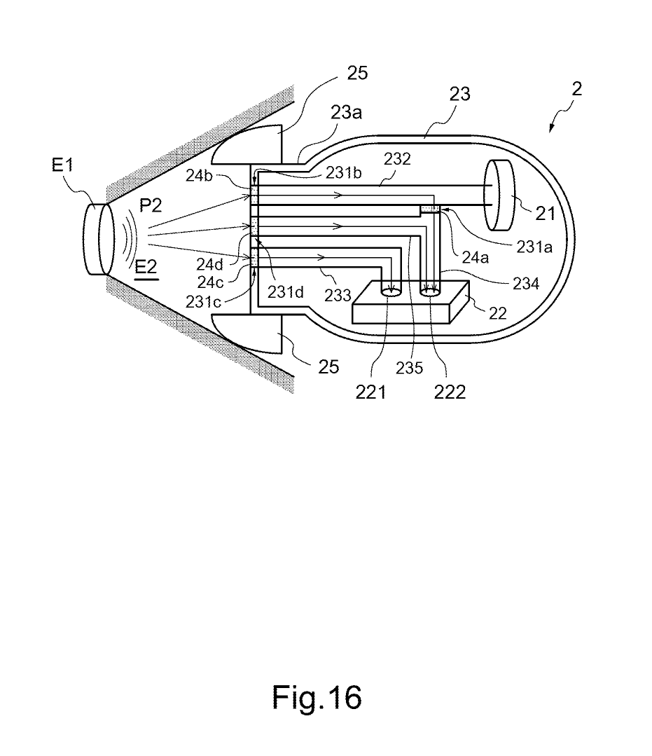

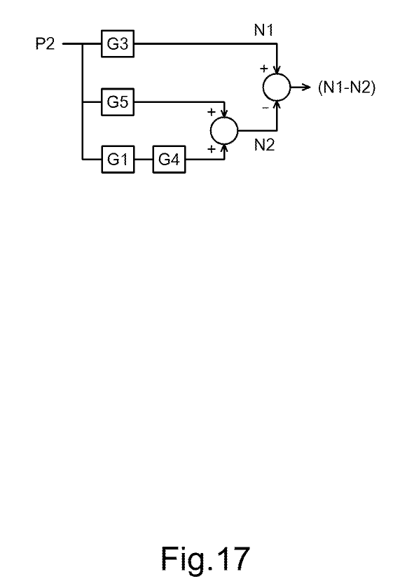

Next, a case where the input sound from the outside sound source (such as user's speaking voice) is input to the microphone 22 is described. FIG. 16 is a conceptual structural diagram illustrating a propagation path of the input sound from the outside sound source to be input to the microphone in the second embodiment. In addition, FIG. 17 is a sound input block diagram of the input sound in the second embodiment. Note that in FIG. 16, the sound output direction of the speaker 21 is substantially parallel to the sound output path 232 for convenience sake.

As illustrated in FIG. 16, when the earphone microphone 1 is inserted in the user's external auditory meatus E2 as illustrated in FIG. 2, the input sound having the sound pressure P2 propagates from the tympanum E1 and the external auditory meatus E2 to the first sound input path 233 and the sound output path 232. The input sound propagating in the first sound input path 233 passes through the third aperture 231c and the first sound input path 233 so as to enter the first sound input hole 221. Therefore, the third sound pressure N1 of the input sound input to the first sound input hole 221 is expressed by the following expression 13 as illustrated in FIG. 17.

N1=P2*G3 (expression 13)

In addition, the input sound propagating in the third sound input path 235 passes through the fourth aperture 231d, the third sound input path 235, and the second sound input path 234 so as to enter the second sound input hole 222. Therefore, the sound pressure of the input sound input to the second sound input hole 222 after propagating in the third sound input path 235 becomes P2*G5 as illustrated in FIG. 17.

In addition, the input sound propagating in the sound output path 232 passes through the second aperture 231b, a part of the sound output path 232, the first aperture 231a, and the second sound input path 234 so as to enter the second sound input hole 222. Therefore, the sound pressure of the input sound input to the second sound input hole 222 after propagating in the sound output path 232 becomes P2*G1*G4 as illustrated in FIG. 17.

For this reason, the fourth sound pressure N2 of the input sound input to the second sound input hole 222 is expressed by the following expression 14.

N2=P2*(G5+G1*G4) (expression 14)

Here, if one of the third sound pressure N1 of the first sound input hole 221 and the fourth sound pressure N2 of the second sound input hole 222 is larger than the other, the input sounds cannot be canceled, and a difference sound signal having an amplitude corresponding to the difference |N1−N2| between them is generated. Therefore, the expressions 15 and 16 are derived as follows.

|N1−N2|=|P2*(G3−G5+G1*G4)|>0 (expression 15)

|G3−(G5+G1*G4)|0 (expression 16)

In other words, when the sound transmission ratios G0 to G5 are set so that the expression 15 (expression 16) is satisfied, the input sounds from the outside sound source are not canceled by the echo suppression function, and the difference sound signal having the sound pressure level corresponding to the difference |N1−N2| between the third and fourth sound pressures N1 and N2 is generated. Therefore, the earphone microphone 1 can transmit the input sound from the outside sound source (such as user's speaking voice) to the electronic equipment without mixing the echo component of the output sound from the speaker 21 as noise.

For instance, the sound transmission ratios of the acoustic resistances of the sound paths are set as G1=0.70, G3=0.94, G4=0.25, and G5=0.05. Then, the third sound pressure becomes N1≈(0.94*P2), and the fourth sound pressure becomes N2≈(0.23*P2). Therefore, the earphone microphone 1 can transmit the input sound having an amplitude corresponding to the difference |0.71*P2| to the electronic equipment. Note that these set values are an example, and the application range of the present invention is not limited to this example. The difference |N1−N2| between the third and fourth sound pressures N1 and N2 is preferably larger, and more preferably (0.7*P2) or larger, for example.

In addition, the sound transmitted by the earphone microphone 1 becomes largest in the condition where the difference |N1−N2| between the third and fourth sound pressures N1 and N2 becomes largest. Therefore, it is desired that the sound transmission ratios G0 to G5 are set to the condition where |G3-(G5+G1*G4)| becomes largest (namely, the condition where the value of the expression 15 or 16 becomes largest). In this way, the sound pressure level of the input sound in which the noise due to the echo component of the output sound from the speaker 21 is suppressed can be largest. Therefore, the input sound input from the outside sound source to the earphone microphone 1 can be transmitted with the highest sound pressure level.

### ((Suppression of Echo Component))

In reality, in the microphone 22, the output sound from the speaker 21 and the input sound from the outside sound source (such as user's speaking voice) are input simultaneously. For this reason, the sound transmission ratios G0 to G5 are set so that the value of the expression 11 becomes smaller in the condition satisfying the expression 16. In this way, the echo suppression function can be realized in the earphone microphone 1, and it is possible to transmit to the electronic equipment (not shown) the input sound in which the echo component of the output sound from the speaker 21 is suppressed by the echo suppression function.

In addition, it is desired that the sound transmission ratios G0 to G5 are set so that the expressions 12 and 16 are both satisfied. In this way, the echo suppression function of the earphone microphone 1 is used to the full, and hence the input sound from which the echo component of the output sound from the speaker 21 is substantially removed can be transmitted to the electronic equipment (not shown).

Note that as described above, in the condition where the value of the expression 15 or 16 is small, the sounds input through the first and second sound input holes 221 and 222 are easily canceled by each other. Therefore, it is desired that the sound transmission ratios G0 to G5 are set to a condition where the value of the expression 16 becomes largest in the condition where the expression 12 is satisfied. In this way, the earphone microphone 1 can transmit the input sound from which the echo component of the output sound from the speaker 21 is substantially removed can be transmitted to the electronic equipment (not shown).

The second embodiment is described above. According to the second embodiment, the acoustic space further include the third sound input path 235 communicating from the outside of the main body casing 23 to the second sound input path 234.

With this structure, even if the acoustic resistance (indicated by the sound transmission ratio G1) for attenuating the sound propagating in the sound output path 232 is lowered, the echo suppression function can be sufficiently realized. Further, the output sound from the speaker 21 propagating in the sound output path 232 can be output to the outside of the earphone microphone 1 without attenuating the sound pressure of the output sound so much. Therefore, the user can hear the output sound from the speaker 21 more clearly.

### Third Embodiment

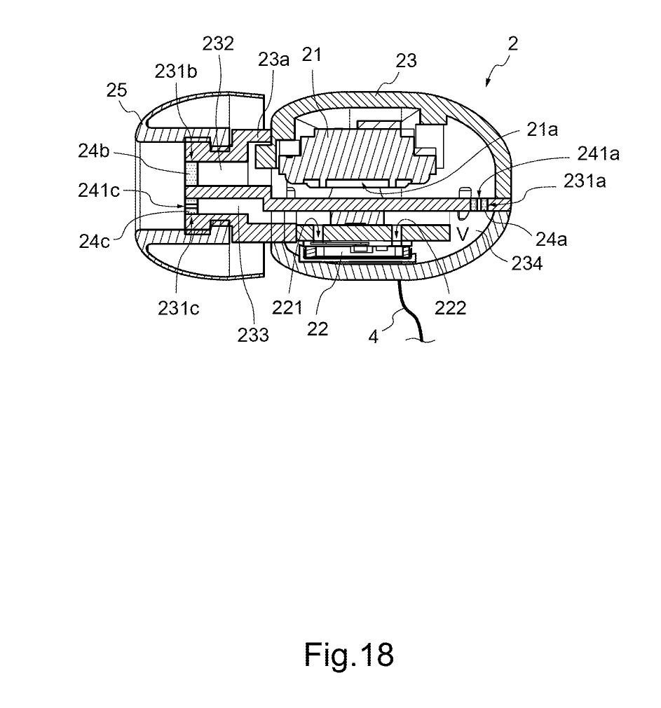

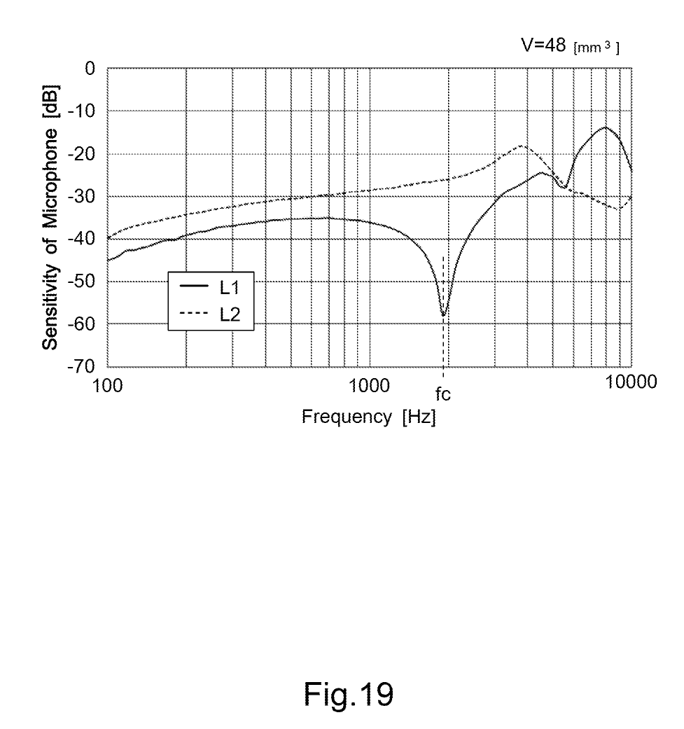

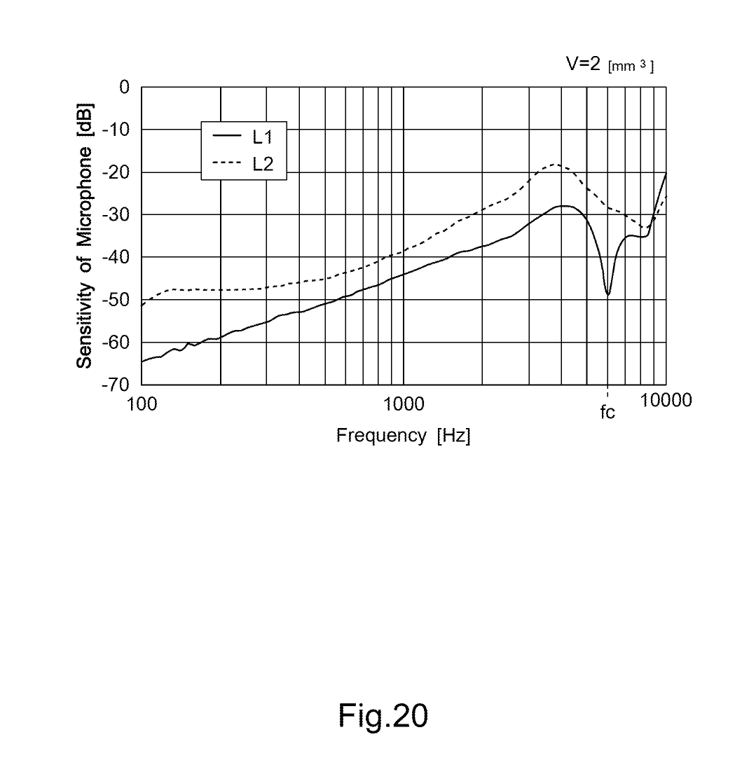

Next, the earphone microphone 1 of a third embodiment is described. FIG. 18 is a cross-sectional view of a main body in the third embodiment. FIG. 19 is a graph showing an example of sensitivity characteristics of the microphone in a case where capacity of the second sound input path is relatively large in the third embodiment. In addition, FIG. 20 is a graph showing an example of the sensitivity characteristics of the microphone in a case where the capacity of the second sound input path is relatively small in the third embodiment. Note that in FIGS. 19 and 20, a characteristic curve L1 of a solid line indicates frequency characteristics of the output sound from the speaker 21 to be input to the microphone 22. In addition, a characteristic curve L2 of a broken line indicates frequency characteristics of the input sound from the outside sound source (such as user's speaking voice) to be input to the microphone 22.

In the third embodiment, a through hole 241a is formed in the first acoustic resistor 24a disposed in the second sound input path 234 (first aperture 231a). In addition, a through hole 241c is formed in the third acoustic resistor 24c disposed in the first sound input path 233 (third aperture 231c). In addition, echo of the output sound from the speaker 21 to be input to the microphone 22 is suppressed more strongly in a frequency band near a center frequency fc corresponding to a capacity V of the second sound input path 234 than in outside of the frequency band. Other than that is the same as in the first embodiment. In the following description, the same structure as in the first embodiment is denoted by the same numeral, and description thereof is omitted.

As illustrated in FIG. 18, the through holes 241a and 241c are formed in the first and third acoustic resistors 24a and 24c, respectively. An inner diameter of the through holes 241a and 241c is preferably 1 mm or smaller and more preferably 50 to 800 μm. In this way, in a high frequency band in which the effect of the echo suppression function is usually hard to work, the echo component of the output sound from the speaker 21 can be suppressed more strongly.

The echo component of the output sound from the speaker 21 is strongly suppressed at a frequency band near the center frequency fc corresponding to the capacity V of the second sound input path 234. For instance, when the capacity of the second sound input path 234 is 48 mm³, as illustrated in FIG. 19, a peak with lowest sensitivity at the center frequency fc=1,900 Hz appears in the characteristic curve L1, but such a peak does not appear in the characteristic curve L2. In addition, when the capacity of the second sound input path 234 is 2 mm³, as illustrated in FIG. 20, a peak with lowest sensitivity at the center frequency fc=6,000 Hz appears in the characteristic curve L1, but such a peak does not appear in the sensitivity of the characteristic curve L2. In this way, the output sound from the speaker 21 to be input to the microphone 22 is suppressed more strongly in the frequency band near the center frequency fc than in outside of the frequency band. On the other hand, the input sound from the outside sound source to be input to the microphone 22 is not strongly suppressed in particular in the frequency band near the center frequency fc.

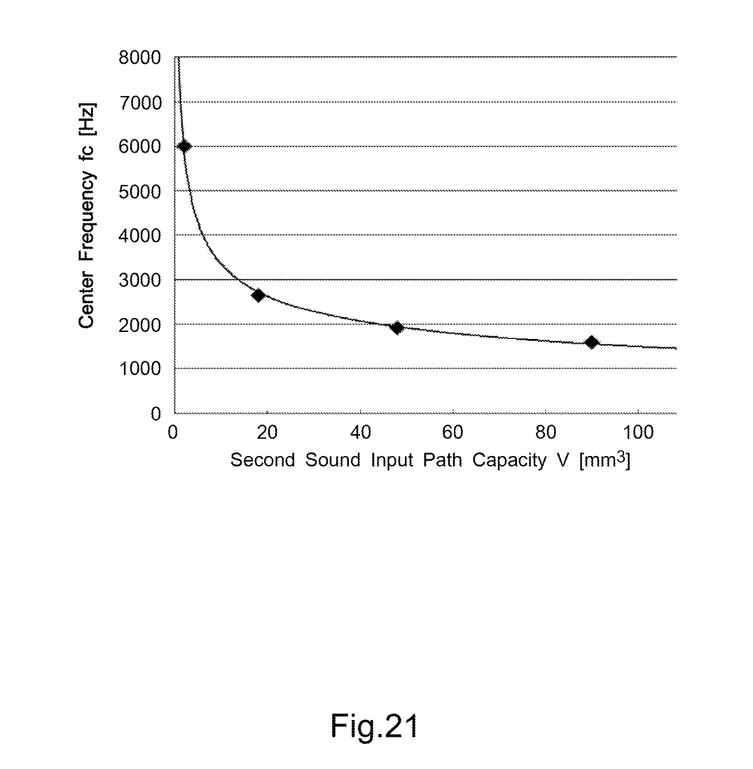

In addition, as illustrated in FIGS. 19 and 20, the variation of the center frequency fc of the peak indicated by the characteristic curve L1 shows a behavior opposite to the variation of the set value of the capacity V of the second sound input path 234. FIG. 21 is a graph showing the variation of the center frequency with respect to the capacity of the second sound input path. As illustrated in FIG. 21, the center frequency fc at which the echo component of the output sound from the speaker 21 is suppressed most strongly varies in inverse proportion to the set value of the capacity V of the second sound input path 234, and becomes a frequency of appropriately 1,000 Hz or higher. Therefore, by using this phenomenon, the center frequency fc can be set to a frequency corresponding to the capacity V of the second sound input path 234. Therefore, by appropriately setting the capacity V of the second sound input path 234, noise due to the output sound from the speaker 21 can be suppressed more strongly in a desired frequency band. In particular, in a high frequency band in which the effect of the echo suppression function is usually hard to work, noise due to the output sound from the speaker 21 can be suppressed more effectively.

### Modified Example of Third Embodiment

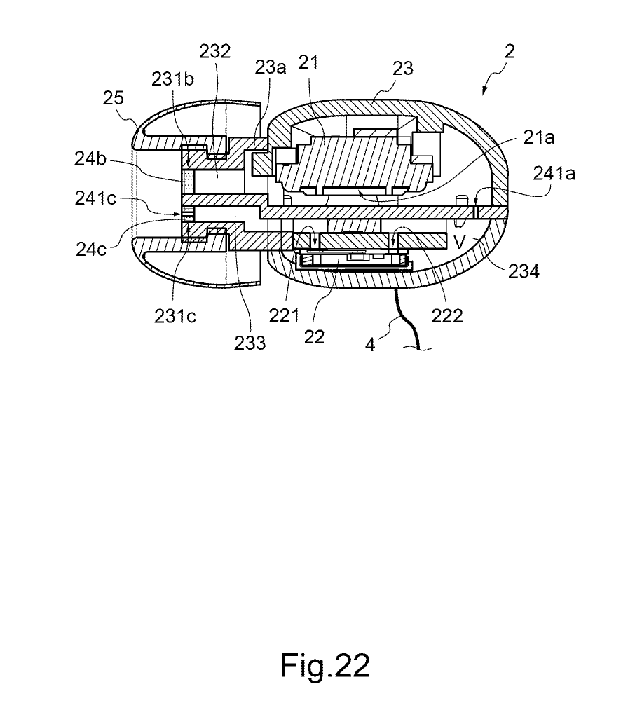

The through hole 241a is formed in the first acoustic resistor 24a disposed in the first aperture 231a in FIG. 18, but the through hole 241a may be directly formed in the main body casing 23 instead of the first aperture 231a and the first acoustic resistor 24a. FIG. 22 is a cross-sectional view of the main body in a modified example of the third embodiment.

In the modified example of the third embodiment, as illustrated in FIG. 22, the through hole 241a is formed in a partition between the sound output path 232 (the other path thereof) and the second sound input path 234. Note that the structure illustrated in FIG. 22 can be considered in the same manner as a structure in which the first aperture 231a is the through hole 241a having an inner diameter of 1 mm or smaller, and the first acoustic resistor 24a is not disposed in the first aperture 231a in FIG. 18. In this way, it is sufficient that the second sound input path 234 communicates with the other path of the sound output path 232 via the through hole 241a having an inner diameter of 1 mm or smaller.

Note that as illustrated in FIGS. 18 and 22, the through hole 241c is formed also in the third acoustic resistor 24c disposed in the first sound input path 233 (third aperture 231c) in the third embodiment and its modified example, but the present invention is not limited to this structure. The through hole 241c may not be formed in the third acoustic resistor 24c. Regardless of presence or absence of the through hole 241c, by disposing the third acoustic resistor 24c in the first sound input path 233 (third aperture 231c), it is possible to enhance the effect of suppressing the output sound from the speaker 21 to be input to the microphone 22 in substantially the entire frequency band.

The third embodiment and the modified example thereof are described above. According to the third embodiment and the modified example thereof, the second sound input path 234 communicates with the other path of the sound output path 232 via the through hole 241a having an inner diameter of 1 mm or smaller. In addition, input of the output sound from the speaker 21 is suppressed more strongly in a frequency band near the center frequency fc corresponding to the capacity V of the second sound input path 234 than in outside the frequency band.

In this way, it is possible to suppress noise due to the output sound from the speaker 21 more strongly in a desired frequency band by appropriately setting the capacity V of the second sound input path 234. In particular, in a high frequency band in which the effect of the echo suppression function is usually hard to work, noise due to the output sound from the speaker 21 can be suppressed more effectively.

Further, according to the third embodiment and the modified example thereof, the center frequency fc corresponding to the capacity V of the second sound input path 234 is 1 kHz or higher. In this way, noise due to human voice contained in the output sound from the speaker 21 can be suppressed more effectively.

In addition, according to the third embodiment and the modified example thereof, the third acoustic resistor 24c is disposed in the first sound input path 233. In this way, it is possible to enhance the effect of suppressing noise due to the output sound from the speaker 21 in substantially the entire frequency band.

The embodiments of the present invention are described above. Note that the embodiments described above are merely examples, and combinations of the components and the processes can be modified variously, which are understood to be in the scope of the present invention by a skilled person in the art.

For instance, in the first to third embodiments, the main body 2 includes the microphone 22 having two sound input holes, but the application range of the present invention is not limited to this structure. The microphone 22 may be constituted of a first microphone having a first sound input hole and a second microphone having a second sound input hole. In addition, the earphone microphone 1 may generate a difference sound signal based on the first and second sound signals by a control circuit portion (not shown), or the difference sound signal may be generated by electronic equipment (not shown) connected to the earphone microphone 1.

In addition, in the first and second embodiments described above, the acoustic resistors 24a to 24d are respectively disposed in the sound paths 232 to 235 included in the acoustic space, but the present invention is not limited to this structure. The acoustic resistor may be disposed in at least one of the sound paths 232 to 235 included in the acoustic space. In this way, it is possible to set acoustic resistance in the sound paths in which the acoustic resistors 24a to 24d (at least one of the acoustic resistances indicated by the sound transmission ratios G1 and G3 to G5) without restricted by shapes and sizes of the sound paths 232 to 235. Therefore, it is possible to enhance flexibility in designing the earphone microphone 1 and to easily realize the echo suppression function.

In addition, the acoustic resistor 24b is disposed in the second aperture 231b communicating with the sound output path 232 in the first to third embodiments, but the present invention is not limited to this structure. It is desired to set the acoustic resistance for attenuating the sound output from the speaker 21 to the outside of the main body casing 23 to be as small as possible. In other words, it is desired that the sound transmission ratios G0 and G1 are close to one as much as possible. For this reason, the acoustic resistor 24b may not be disposed in the second aperture 231b (or the sound output path 232). In this way, the output sound from the speaker 21 is output to the external auditory meatus E2 with little attenuation by influence of the second acoustic resistor 24b, and hence the sound transmission ratio G1 can be made close to one. Therefore, the user can hear the output sound from the speaker 21 at higher sound pressure level.

In addition, in the first to third embodiments, the earphone microphone 1 includes the single main body 2 as illustrated in FIG. 1, but the present invention is not limited to this structure. The earphone microphone 1 may include two main bodies 2. Further, one of the two main bodies 2 may not have the echo suppression function. In other words, it may be configured so that one of the two main bodies 2 includes the speaker 21 but does not include the microphone 22. In this way, the user can hear the output sound from the earphone microphone 1 by both ears.

In addition, in the first and second embodiments described above, in order to facilitate understanding of the structure for realizing the echo suppression function of the earphone microphone 1, the conceptual structural diagram and the sound input block diagram of the earphone microphone 1 are illustrated separately in FIGS. 7 to 10 and in FIGS. 11 and 14 to 17. The structure illustrated in FIGS. 11 and 14 to 17 can be considered to be substantially the same as that illustrated in FIGS. 7 to 10 if the acoustic resistance of the fourth acoustic resistor 24d is R4≈1.

What is claimed is:

1. An earphone microphone comprising:
a single speaker;
a microphone having first and second sound input holes; and
a main body casing in which an acoustic space is formed, wherein
the acoustic space includes a sound output path in which output sound from the speaker propagates, a first sound input path communicating with outside of the main body casing, in which sound to be input to the first sound input hole propagates, and a second sound input path in which sound to be input to the second sound input hole propagates,
the sound output path branches into one path communicating with the outside of the main body casing and the other path communicating with the second sound input path, and
input sound from a sound source outside the main body casing is input while input of the output sound from the speaker is suppressed by acoustic resistance of the acoustic space.

2. The earphone microphone according to claim 1, wherein
a first sound pressure of the output sound from the speaker to be input to the first sound input hole becomes substantially equal to a second sound pressure of the output sound to be input to the second sound input hole because of the acoustic resistance of the acoustic space, and
one of a third sound pressure of the input sound from the outside sound source to be input to the first sound input hole and a fourth sound pressure of the input sound to be input to the second sound input hole becomes larger than the other because of the acoustic resistance of the acoustic space.

3. The earphone microphone according to claim 1, further comprising an acoustic resistor disposed in at least one of the sound paths included in the acoustic space.

4. The earphone microphone according to claim 3, wherein the acoustic resistor is not disposed in the sound output path.

5. The earphone microphone according to claim 3, wherein acoustic resistance of the acoustic resistor is set in such a manner
that the first sound pressure of the output sound to be input to the first sound input hole is substantially equal to the second sound pressure of the output sound to be input to the second sound input hole, and
that a difference between the third sound pressure of the input sound to be input to the first sound input hole and the fourth sound pressure of the input sound to be input to the second sound input hole becomes largest.

6. The earphone microphone according to claim 4, wherein acoustic resistance of the acoustic resistor is set in such a manner
that the first sound pressure of the output sound to be input to the first sound input hole is substantially equal to the second sound pressure of the output sound to be input to the second sound input hole, and
that a difference between the third sound pressure of the input sound to be input to the first sound input hole and the fourth sound pressure of the input sound to be input to the second sound input hole becomes largest.

7. The earphone microphone according to claim 1, wherein the acoustic space further comprising a third sound input path communicating from outside of the main body casing to the second sound input path.

8. The earphone microphone according to claim 1, wherein
the second sound input path communicates with the other path of the sound output path via a through hole having an inner diameter of 1 mm or smaller, and
input of the output sound from the speaker is suppressed more strongly in a frequency band near a frequency corresponding to the second sound input path capacity than in outside the frequency band.

9. The earphone microphone according to claim 8, wherein the frequency corresponding to the second sound input path capacity is 1 kHz or higher.

10. The earphone microphone according to claim 8, wherein the acoustic resistor is disposed in the first sound input path.

11. The earphone microphone according to claim 9, wherein the acoustic resistor is disposed in the first sound input path.
